(19) United States
(12) Patent Application Publication
(10) Pub. No.: US 2006/0130154 A1
(43) Pub. Date: Jun. 15, 2006

(54) Method and system for protecting and verifying stored data

(76) Inventors: Wai Lam, Jericho, NY (US); Xiaowei Li, Hauppauge, NY (US)

Correspondence Address: KAYE SCHOLER LLP, 425 PARK AVENUE, NEW YORK, NY, 10022-3598, US

(21) Appl. No.: 10/999,683

(22) Filed: Nov. 30, 2004

(51) Int. Cl. G06F 17/30

(52) U.S. Cl. 726/30

(57) ABSTRACT

A data file stored in a file volume is locked such that subsequent alterations to the contents of the file may be detected. A data protection module retrieves the data file from storage, hashes the data file, generating a file digest, and stores the file digest in a record. A data segment comprising the file digest is defined and transmitted to a smart card. The smart card hashes the segment, generating a segment digest, and uses a private key to encode the segment digest, generating a digital signature. The digital signature is stored in the record. The record is subsequently used to verify the contents of the data file. The smart card's public key is used to decode the digital signature, generating a decoded value. The defined segment within the record is retrieved, and a segment digest is recomputed based on the segment. The decoded value is compared to the recomputed segment digest. If the decoded value is the same as the recomputed segment digest, the contents of the segment are determined to be valid.

### BACKGROUND OF THE INVENTION

1. Field of the Invention

The invention relates generally to methods and systems for storing data, and more particularly, to methods and systems for verifying the integrity of data stored in a communication system.

2. Description of the Related Art

In many computing environments, large amounts of data are written to and retrieved from storage devices connected to one or more computers. In many such networks, much of the stored data is relatively unprotected and vulnerable to being altered by a variety of parties including hackers, employees, etc.

For many users, protecting the integrity of stored data is an essential element of their data processing operations. Accordingly, there exists an ongoing need for effective systems and methods to verify the integrity of stored data. One approach that is commonly used involves the use of a known function to generate, for a respective data block, a value (often referred to as a “digest”) that represents the contents of the data block. When the data block is stored, the corresponding digest is stored with the block. Subsequently, the stored digest may be used to verify the integrity of the data block. The data block is retrieved from storage and used to recompute the digest. The recomputed digest is compared to the stored digest; if the two values match, the data block is deemed to be valid, i.e., it has not been altered. If the recomputed digest is different from the stored digest, the data block is deemed to be corrupted.

To be practical, a digest should be substantially smaller than the data block. Ideally, each digest is uniquely associated with the respective data block from which it is derived. A function which generates a unique digest for each data block is said to be “collision-free.” In practice, it is sometimes acceptable to utilize a function that is substantially, but less than 100%, collision-free. A digest-generating function is referred to herein as a D-G function.

Any one of a wide variety of functions can be used to generate a digest. For example, one well-known D-G function is the cyclic redundancy check (CRC). Cryptographically strong hash functions are also often used for this purpose. A hash function performs a transformation on an input and returns a number having a fixed length—a hash value. Several well-known hash functions include the ability to (1) take a variable-sized input and generate a fixed-size output, (2) compute the hash relatively easily and quickly for any input value, and (3) be substantially (or “strongly”) collision-free. Examples of hash functions satisfying these criteria include, but are not limited to, the message digest 5 (MD5) algorithm and the secure hash (SHA-1) algorithm.

The MD5 algorithm generates a 16-byte (128-bit) hash value. It is designed to run on 32-bit computers. MD5 is substantially collision-free. Using MD5, hash values may be typically generated at high speed. The SHA-1 algorithm generates a 20-byte (160-bit) hash value. The maximum input length of a data block to the SHA-1 algorithm is 264 bits (˜1.8×10¹⁹ bits). The design of SHA-1 is similar to that of MD5, but because its output is larger, it is slightly slower than MD5, although it is more collision-free.

Although systems using D-G functions in the manner described above are commonly used to protect stored data, such systems are not foolproof. A resourceful party may circumvent such a system and alter a selected data block without detection by additionally replacing the corresponding stored digest with a second digest that corresponds to the altered data block. In such case, when the verification procedure is performed, the alteration may not be not detected. Similarly, in some systems, the data verification procedure may not detect a problem if a data block and its corresponding digest are deleted entirely.

Symmetric and Asymmetric Encryption

The field of encryption offers a number of alternative techniques for transforming and/or encrypting data in addition to the D-G functions discussed above. Two encryption techniques that are commonly used in communication systems are known as symmetric encryption and asymmetric encryption.

In a symmetric encryption system, a single key, referred to as the symmetric key, is used for both encryption and decryption. In the context of encryption technology, a “key” is typically a digital value, e.g., a random number. As long as the symmetric key is kept secure, a symmetric encryption system offers a relatively secure method for encrypting data.

In an asymmetric encryption system, two different keys are used. A first key, referred to as the private key, is kept secret by a user. A second key, referred to as the public key, is available to anyone wishing to communicate with the user in a confidential manner. The two keys uniquely match each other; however, the private key cannot be derived easily from the public key. The public key and the private key are collectively referred to as a “public key-private key pair.” Asymmetric encryption systems are often used in data communications. A party wishing to send a message to the user may utilize the public key to encode a message before transmitting it. The user then utilizes the private key to decode the message. It should be noted that in an asymmetric encryption system, the private key can also be used to encode a message, in which case the message can subsequently be decoded with the public key. Asymmetric encryption is also referred to as public key encryption.

Digital Signatures

Public key encryption systems are often utilized for authentication purposes. A first party wishing to authenticate a data file may encode the document using its private key, and transmit the data file, and the resulting encoded value, to a second party. The second party may then utilize the first party's known public key to decode the encoded value, generating a decoded value. The decoded value is compared to the data file received from the first party; if the received document and the decoded value match, the first party may be confident of the first party's identity.

In practice, a more efficient variation of the above procedure is often utilized to authenticate data files. The first party uses a known D-G function to generate a digest representing the data file, and then encodes the digest with the first party's private key. A digest encoded using a private key is sometimes referred to as a digital signature. The first party sends the data file, and the digital signature, to the second party. The second party may verify the identity of the first party by using the first party's public key to decode the digital signature, generating a decoded value. The second party separately applies the known D-G function to the data file received from the first party to generate a verification digest. The verification digest is compared to the decoded value; if the two match, the second party can be confident of the first party's identity and of the integrity of the data file's contents.

Digital Certificates

The techniques described above are useful when the second party has knowledge of the first party's public key. However, in many instances, the second party may not have such knowledge, and therefore cannot perform the steps necessary to authenticate the first party's transmissions. A common solution to this problem is to use digital certificates issued by a commonly-known, trusted entity. A digital certificate has value if both the first and second parties trust the certificate issuer and have knowledge of the issuer's public key. In such case, the trusted entity may issue a certificate to the first party, containing (1) a version of the first party's public key and (2) a digital signature of the certificate signed by the trusted entity using its private key. The first party may accordingly provide the certificate to the second party, who utilizes the trusted entity's public key to verify the certificate and extract the first party's public key. A commonly used specification for generating digital certificates is described in the. ISO/X.509 standards published by the International Organization for Standardization. A trusted entity which issues digital certificates in the manner described above is referred to as a “certificate authority.”

### SUMMARY OF THE INVENTION

Improved systems and methods for protecting and verifying stored data are provided. In accordance with an embodiment of the invention, a data file stored in a file volume is locked such that subsequent alterations made to the contents of the file may be detected. A data protection module retrieves the data file from storage, applies a D-G function to the data file, generating a file digest, and stores the file digest in a record within a journal file. The file digest may be generated using a hash function such as, e.g., the well-known MD5 algorithm. Identification information pertaining to all or portions of the record is also stored in the record, such as, e.g., a timestamp indicating when the file digest is created, a serial number, etc. Additional information pertaining to the data file may also stored in the record, such as, e.g., file address data, file metadata, etc. The data protection module defines a data segment comprising the file digest, the identification information, and, optionally, other selected portions of the record, and transmits the segment to a secure encryption device with a request that the device apply a D-G function to the segment, and sign the resulting segment digest. The secure encryption device may include, for example, a secure memory from which data cannot be retrieved without damaging the device.

In accordance with an embodiment of the invention, the secure encryption device may include, e.g., a smart card. The smart card holds in a secure memory a public key and a corresponding private key. The smart card also holds in a secure memory verification data such as date/time information, serial number data, etc. The verification data is used to guard against attempts to produce back-dated digital signatures. The smart card compares the identification information received in the segment to the verification data stored in its secure memory to determine whether the identification data is valid. If the identification data is determined to be valid, the smart card applies a D-G function to the segment, generating a segment digest, and uses the private key to encode the segment digest, generating a digital signature. The smart card may generate the segment digest using, e.g., a hash function such as the MD5 algorithm. The digital signature is transmitted to the data protection module. The data protection module stores the digital signature in the record. The journal file is stored in association with the data file.

In accordance with an embodiment of the invention, the journal file may subsequently be used to verify the contents of the data file. The data protection module accesses the journal file, and retrieves the record corresponding to the data file. The data protection module retrieves the digital signature from the record, and uses the smart card's public key to decode the digital signature, generating a decoded value. The data protection module also identifies the defined segment within the record, and recomputes a segment digest based on the segment. The decoded value is compared to the recomputed segment digest. If the decoded value is the same as the recomputed segment digest, the contents of the segment are determined to be valid. If the decoded value and the recomputed segment digest are different, the contents of the segment are deemed to be corrupted. If the segment is determined to be valid, the data protection module also verifies the contents of the data file, by recomputing a file digest based on the data file, and comparing the recomputed file digest to the file digest stored in the record. If the recomputed file digest is the same as the stored file digest, the contents of the data file are determined to be valid. If the recomputed file digest and the stored file digest are different, the contents of the data file are deemed to be corrupted.

In accordance with an embodiment of the invention, the data protection module locks multiple data files stored in a file volume. Accordingly, the data protection module generates, in the manner described above, a record in the journal file for each data file within the volume that is selected to be locked. Thus, each record includes a file digest generated based on the corresponding data file, a digital signature generated based in part on the file digest, and other related data. The data protection module subsequently verifies the contents of one or more selected data files using the verification technique described above.

In an alternative embodiment, the data protection module additionally generates, for at least one record in the journal file, a cascaded value by retrieving a digital signature from the record and selected data from at least one previous record in the journal file, and transmitting the digital signature and the selected data to the smart card. The smart card applies a D-G function to the digital signature and the selected data, generating a digest, and encodes the digest using its private key, generating a second digital signature (referred to as a cascaded value). The cascaded value is stored in the at least one record within the journal file.

### BRIEF DESCRIPTION OF THE DRAWINGS

These and other features and advantages of the invention will be apparent to those skilled in the art from the following detailed description of preferred embodiments, taken together with the accompanying drawings, in which:

FIG. 1 illustrates a system for storing data, in accordance with an embodiment of the invention;

FIG. 2 is a schematic illustration of a file volume that may be maintained in the storage system of FIG. 1, in accordance with an embodiment of the invention;

FIG. 3 illustrates a smart card associated with a certificate authority, in accordance with an embodiment of the invention;

FIG. 4 illustrates a smart card used in the embodiment of FIG. 1, in accordance with an embodiment of the invention;

FIG. 5 is a schematic illustration of a time log that may be maintained by the smart card of FIG. 4, in accordance with an embodiment of the invention;

FIG. 6 is a flowchart depicting a routine for locking a selected data file, in accordance with an embodiment of the invention;

FIG. 7 is a schematic illustration of a journal file comprising a single record, in accordance with an embodiment of the invention;

FIG. 8 illustrates a time log, in accordance with an embodiment of the invention;

FIG. 9 is a schematic illustration of a journal file comprising multiple records, in accordance with an embodiment of the invention;

FIG. 10 is a flowchart depicting a routine for verifying the contents of a data segment within a journal file, in accordance with an embodiment of the invention;

FIG. 11 is a flowchart depicting a routine for verifying the contents of a selected data file, in accordance with an embodiment of the invention;

FIG. 12 is a schematic illustration of a journal file, in accordance with an alternative embodiment of the invention;

FIG. 13 is a schematic illustration of a file volume, in accordance with an alternative embodiment of the invention;

FIG. 14 is a flowchart depicting a routine for periodically locking data saved in a file volume, in accordance with an alternative embodiment of the invention; and

FIG. 15 is a schematic illustration of journal file, in accordance with an alternative embodiment of the invention.

### DETAILED DESCRIPTION OF THE PREFERRED EMBODIMENTS

An improved system and method for protecting and verifying data are provided. In accordance with an embodiment of the invention, a data file stored in a file volume is locked such that subsequent alterations to the contents of the file may be detected. A data protection module retrieves the file from storage, applies a D-G function to the data file, generating a file digest, and stores the file digest in a record within a journal file. The file digest may be generated using a hash function such as, e.g., the well-known MD5 algorithm. Additional information pertaining to the file is also stored in the record, such as, e.g., file address data, file metadata, etc. A timestamp indicating when the file digest is created is also stored in the record. The data protection module defines a data segment comprising the file digest and other selected portions of the record, and transmits the segment to a smart card with a request that the smart card hash and sign the segment.

The smart card holds in its memory a public key and a corresponding private key. The smart card applies a D-G function to the segment, generating a segment digest, and uses the private key to encode the segment digest, generating a digital signature. The smart card may generate the segment digest using, e.g., a hash function such as the MD5 algorithm. The digital signature is transmitted to the data protection module. The data protection module stores the digital signature in the record. The journal file is stored in association with the data file. In an embodiment of the invention, the systems and methods described herein may be used, for example, in implementing a write-once-read-many (WORM) system.

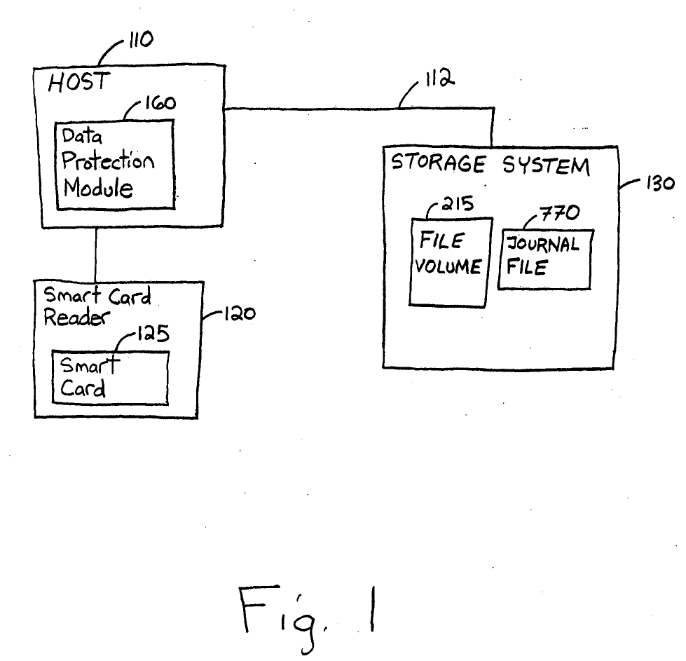

FIG. 1 illustrates a system for storing data, in accordance with an embodiment of the invention. Host 110 is connected to storage system 130 via communication link 112. Host 110 may be any device capable of generating data processing commands such as commands to read data from or write data to a specified file. In one embodiment, host 110 is a computer. In another embodiment, host 110 may be any intelligent storage controller.

In the embodiment shown in FIG. 1, communication link 112 includes a network, such as, for example, an intranet, a local area network (LAN), a wide area network (WAN), an internet, Fibre Channel-based storage area network (SAN) or Ethernet. Alternatively, communication link 112 may include a combination of different types of networks. In yet another embodiment, communication link 112 may comprise a direct connection between host 110 and storage system 130 such as, e.g., a SCSI connection.

In an embodiment of the invention, communications between host 110 and storage system 130 are conducted in accordance with IP or Fibre Channel protocols. For example, host 110 transmits to storage system 130 data processing requests formatted according to IP or Fibre Channel protocols. Thus, host 110 may transmit to storage system 130 a request to retrieve data from a selected file, or blocks of data, and transmit the data to host 110. In response, storage system 130 identifies the location of the file, or the blocks of data, retrieves the requested data, and transmits the data to host 110.

In an embodiment of the invention, storage system 130 may be any device or system that manages data storage tasks on a file-level basis. In the embodiment shown in FIG. 1, storage system 130 includes one or more storage devices (not shown), which may include, for example, disk drives, magnetic tape drives, optical disks, etc. Storage system 130 also includes a controller (not shown) that organizes data in “logical units” (e.g., files) and allows other devices (e.g., host 110) to access data by identifying a logical unit containing the data rather than the physical storage location of the data. Because data stored on storage system 130 may be retrieved by providing to storage system 130 an identifier of a respective logical unit, rather than a physical location, data managed by storage system 130 may be made available to a large number of devices via a network such as, e.g., communication link 112. Storage system 130 permits, for example, cross-platform file sharing via a network. In one embodiment, storage system 130 includes a NAS filer, for example. In another embodiment, storage system 130 includes a file server.

It should be noted that in other embodiments, storage system 130 may organize data on a block-level basis. For example, in one alternative embodiment, storage system 130 may comprise a block-level storage system with protocol connectivity, such as Fibre channel, SCSI, or IDE. In this embodiment, a file volume management system (which manages data at a file level) is located in host 110. In yet another embodiment, data is managed and stored entirely on a block-level basis.

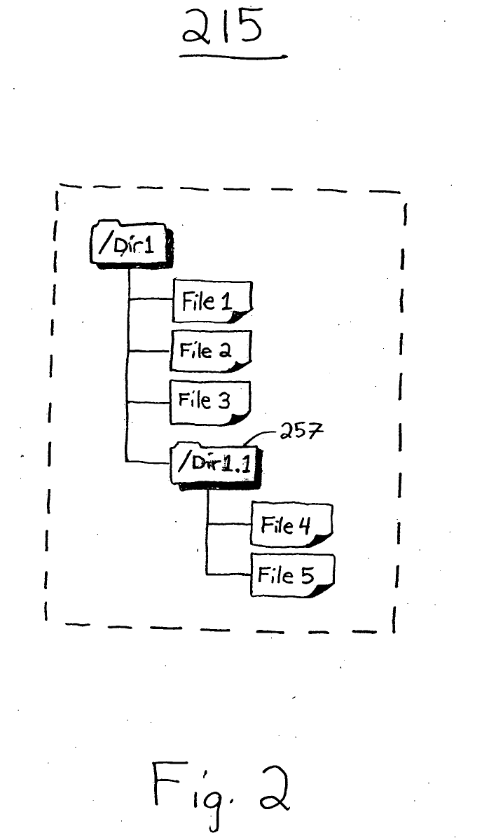

Logical units are often organized into larger groups referred to as “logical volumes,” or, alternatively, “file volumes,” comprising multiple data files organized in one or more directories. As an illustrative example, FIG. 2 illustrates schematically a file volume that may be maintained on storage system 130. Referring to FIG. 2, file volume 215 comprises multiple files, e.g., Files 1, 2, 3, etc., organized in various directories. As an example, subdirectory 257, indicated by “/Dir1.1”, contains File 4 and File 5. Accordingly, each file is associated with a unique storage address specified in part by its directory path. It should be noted at this point that the various data files stored in a file volume (e.g., Files 1, 2, 3, etc.) may be stored collectively on a single storage device, e.g., a single disk drive, or alternatively may be stored collectively on multiple storage devices, e.g., File 1 on a first disk drive, File 2 on a second disk drive, etc.

One advantage associated with file-level storage systems is their ability to enable a host computer to access data without having knowledge of the physical address of the data. Instead, a client computer may access data by identifying a file that contains the data. In the case of a read command, for example, the computer may submit a read command specifying a file containing the requested data, and, in response, the storage system identifies the physical location of the file, accesses the file and provides the requested data to the computer. Accordingly, FIG. 2 may be viewed as a schematic representation of the data stored in volume 215 as it appears to host 110. Based on this file-level representation of data, host 110 may transmit to storage system 130 a command to read, say, File 1, without knowing the location of File 1, or a command to write data to, say, File 4 without knowing the location of File 4. In the embodiment illustrated in FIG. 1, such data processing commands are received and processed by storage system 130 in a manner that is transparent to host 110.

To manage data, storage system 130 may employ any network-based file system. For example, in accordance with one embodiment, storage system 130 may employ the well-known Common Internet File System (CIFS) to enable file sharing over network 112. CIFS defines a standard remote file-system-access protocol for use over the Internet, enabling groups of users to work together, and to share documents across the Internet or within corporate intranets. Among other features, CIFS provides a mechanism for determining the degree to which a host is allowed to access a desired file stored on a remote storage system, based on various factors including the number of other host devices that currently request access to the desired file. In alternative embodiments, storage system 130 may utilize other file sharing protocols, e.g., Network File System (NFS), Apple File System, etc.

Returning to FIG. 1, host 110 includes data protection module 160, which may be, e.g., a software application. From time to time, data protection module 160 retrieves data stored in storage system 130 and processes the data using various techniques. For example, data protection module 160 may from time to time apply a D-G function to selected data to generate a digest. In the illustrative embodiment, the D-G function used by data protection module 160 is a hash function such as, e.g., the MD5 algorithm. However, in various alternative embodiments, other D-G functions may be used. Data protection module 160 may also from time to time transmit data to be stored in one or more files in storage system 130.

Host 110 is connected to a smart card reader 120. Accordingly, data protection module 160 may communicate with smart card 125, which is inserted from time to time in reader 120. A “smart card” is a well-known device typically comprising a credit card-sized plastic card having an embedded microprocessor chip. Two basic types of smart cards are commonly used: a smart card having various electrical contacts connected to the microprocessor chip, and a contactless smart card having no such contacts. Electronic properties and transmission characteristics of smart cards are defined in the ISO/IEC 7816 joint standards published by the International Organization for Standardization and the International Electrotechnical Commission (the “ISO/IEC 7816 joint standards”).

Smart cards are considered to be extremely secure. It is generally considered very difficult to retrieve any data from a smart card's memory (other than data which the internal software directs the smart card to output), without damaging or destroying the smart card itself. Similarly, it is generally considered very difficult to alter any information stored within a smart card, such as, e.g., software that resides and operates therein.

It should be noted that while the illustrative embodiment shown in FIG. 1 includes smart card 125, it is contemplated that any device that provides the functionality of a smart card may be used. Such a device may include features such as, for example, secure circuitry that renders it difficult or impossible to gain access to data stored therein without damaging the device, the ability to perform asymmetric cryptography, etc. Devices having such features may include, for example, a smart key, integrated circuit, etc. Any such device preferably includes a processor and memory, and is capable of being removably coupled to a computer or other device that can transmit data thereto and receive data therefrom.

In accordance with an embodiment of the invention, data protection module 160 “locks” one or more selected data files stored in storage system 130 such that subsequent alterations to the data file(s) may be detected. Data protection module 160 generates a digest based on the contents of the selected file, and saves the digest in a record within a journal file. Data protection module 160 submits a segment of data including the digest to smart card 125, and receiving from smart card 125 a digital signature generated, based at least in part, on the data segment. The digital signature is stored in the record. The journal file is stored in storage system 130 in association with the protected file. At a subsequent time, the integrity of the data in the protected file may be verified using the digital signature and the digest. Because a digital signature generated by a smart card is utilized to verify the data segment, the inventive system and method for protecting and verifying data is very secure. It is very difficult to retrieve a private key from a smart card; therefore, the possibility that the digital signature may be altered in order to mask an altered data file or data segment is very low. Further, smart card 125 maintains a time log (as described below) and an internal timer which are used to guard against attempts to produce back-dated digital signatures.

By way of example, let us suppose that storage system 130 is owned and operated by XYZ Company. Suppose further that XYZ Company wishes to lock one or more data files stored in system 130 to ensure that the data stored therein remains unchanged. In accordance with an embodiment of the invention, before any data is locked within storage system 130, a trusted certificate authority (the “CA”) is designated, which, in this example, may relate to an executive of XYZ Company. A master public key-private key pair associated with the CA is generated. The master public key and master private key are referred to individually as the CA public key and CA private key, and collectively as the CA key pair. The CA key pair is installed in a master smart card (the “CA smart card”), which is typically safeguarded such that only the trusted certificate authority has access thereto.

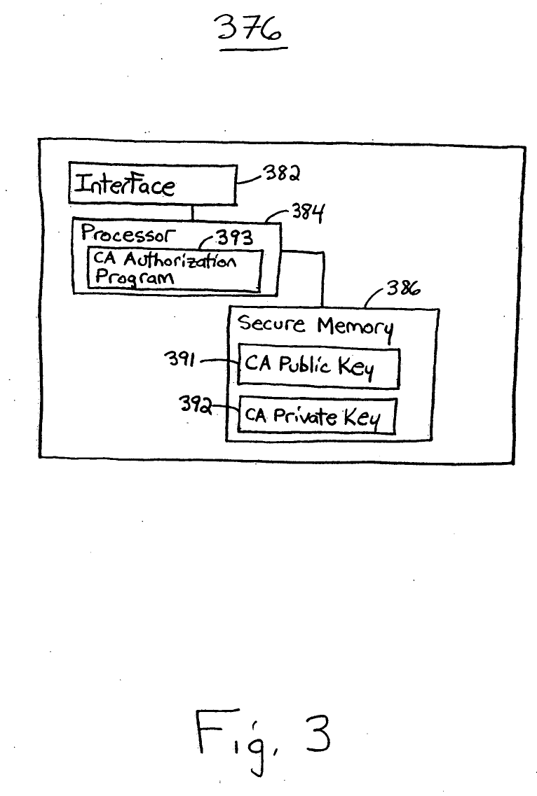

FIG. 3 illustrates such a smart card—CA smart card 376—comprising interface 382, processor 384, and secure memory 386. CA public key 391 and CA private key 392 are stored in secure memory 386. Processor 384 includes a CA authorization program 393, which may be, e.g., a software application. Among other tasks, CA authorization program 393 may from time to time authorize another smart card to lock data stored in a selected volume within storage system 130.

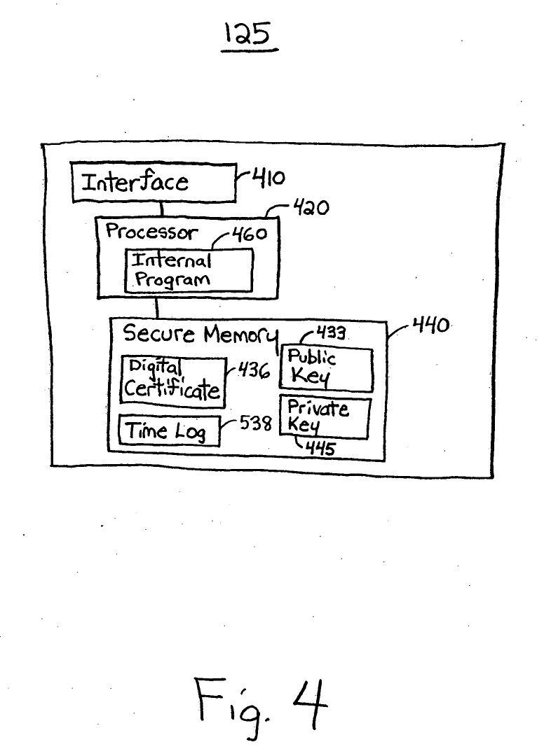

For example, in the illustrative embodiment of FIG. 1, let us suppose that smart card 125 receives authorization from CA smart card 376 to protect data stored in volume 215. Referring to FIG. 4, smart card 125 comprises interface 410, processor 420, and secure memory 440. Processor 420 may include, e.g., an embedded microprocessor chip (not shown). Both CA smart card 376 and smart card 125 conform to the standards set forth in the ISO/IEC 7816 joint standards.

Smart card 125 receives authorization from CA smart card 376 in a well-known manner. Smart card 125 generates a public key (public key 433) and a private key (private key 445), which are saved in secure memory 440. Smart card 125 subsequently creates an (unsigned) digital certificate containing a copy of its public key 433. The digital certificate also includes a start date and expiration date indicating the time period during which the certificate is valid. Smart card 125 submits the digital certificate to CA smart card 376. CA smart card 376 uses CA private key 392 to sign the certificate, and returns the signed certificate to smart card 125. Smart card 125 stores the signed digital certificate (represented in FIG. 4 as digital certificate 436) in secure memory 440. In an alternative embodiment, smart card 125 may store multiple digital certificates in secure memory 440 representing various parties (including the CA) in a digital certificate hierarchy.

Processor 420 within smart card 125 includes an internal program 460, which may be, e.g., a software application. Internal program 460 may reside in, for example, a secured memory within processor 420. Internal program 460 has a variety of functionalities. For example, internal program 460 from time to time applies a D-G function to selected data to generate a digest. In the illustrative embodiment, the D-G function is a hash function such as, e.g., the MD5 algorithm. However, in various alternative embodiments, other D-G functions may be used. Internal program 460 also from time to time “signs” a digest using the smart card's private key 445, generating an encoded value, or digital signature. Thus, in response to a request to hash and sign a selected data segment, internal program 460 hashes the segment, generating a hash value, and encodes the hash value to produce a digital signature.

In accordance with an embodiment of the invention, internal program 460 additionally maintains time log 538 in secure memory 440. For example, time log 538 holds a date/time value which is updated each time smart card 125 generates a digital signature, and each time smart card 125 is activated or re-activated (i.e., inserted in smart card reader 120). In addition, time log 538 may store a counter, or serial number, which is incremented by one each time a digital signature is generated. Before signing a data segment submitted by data protection module 160, internal program 460 compares date/time information and serial number information received with the data segment to the date/time information and serial number information stored in time log 538, to guard against any attempt to obtain a “back-dated” digital signature.

Internal program 460 additionally maintains an internal timer, which contains a value that continually increases to count the passage of time in selected intervals, e.g., milliseconds. The internal timer is set to zero the first time smart card 125 is inserted in smart card reader 120. Subsequently, the internal timer is reset to zero each time smart card 125 generates a digital signature, and each time smart card 125 is activated or re-activated (i.e., inserted in reader 120). The internal timer does not function when smart card 125 is removed from reader 120.

In addition, internal program 160 enters an “idle” mode for a predetermined period of time (e.g., one hour) after being inserted in reader 120. When in idle mode, internal program 160 does not hash any data and does not generate any digital signatures. The idle mode is an additional protective mechanism which guards against attempts to falsify large numbers of records within a short period of time.

In the illustrative embodiment, after smart card 125 receives authorization to lock data stored in volume 215, the card is activated for the first time by being inserted in smart card reader 120. When smart card 125 is activated, internal program 460 sets the internal timer to zero. The value stored in the internal timer then begins to increase to mark the passage of time.

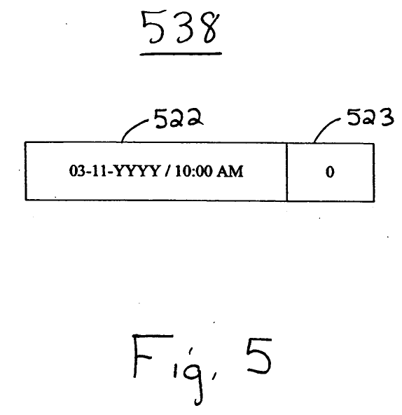

Similarly, when smart card 125 is first inserted into reader 120, time log 538 is initialized. In the illustrative embodiment, an initial date is selected and entered in date/time field 522, and serial number field 523 is set to zero. FIG. 5 illustrates schematically time log 538, comprising fields 522 and 523. Field 522 stores a date/time value representing a smart card-associated “event,” i.e., generation of a digital signature or insertion of smart card 125 in reader 120. Field 523 stores a serial number which is incremented by one each time smart card 125 generates a digital signature. As shown in FIG. 5, when smart card 125 is first inserted into reader 120, internal program 460 enters the activation date/time in field 522, which is “03-11-YYYY/10:00 AM” in this example. Internal program 460 enters a zero in field 523, indicating that no digital signature has yet been generated. It should be noted that other initial date/time values may be chosen, such as, e.g., the starting date and time specified in digital certificate 436. Similarly, any initial serial number may be selected and entered into field 523.

In an alternative embodiment, data protection module 160 itself is hashed and signed by CA authorization program 393 (in CA smart card 376) using CA private key 392. The resulting digital signature may be stored in host 110 in association with data protection module 160.

Journal File

Suppose that after smart card 125 is inserted in reader 120, data protection module 160 receives a request to lock File 1 of volume 215. To protect File 1, data protection module 160 generates a file digest based on the file's contents. Data protection module 160 then creates a data segment comprising the file digest and other related data including, e.g., a timestamp, and transmits the data segment to smart card 125. Smart card 125 hashes the data segment, and signs the resulting hash value, generating a digital signature. Smart card 125 transmits the digital signature to data protection module 160. The file digest and the other related information included in the data segment are stored together with the digital signature in a record within a data file referred to as a “journal file.” The journal file is stored in storage system 130 in association with volume 215.

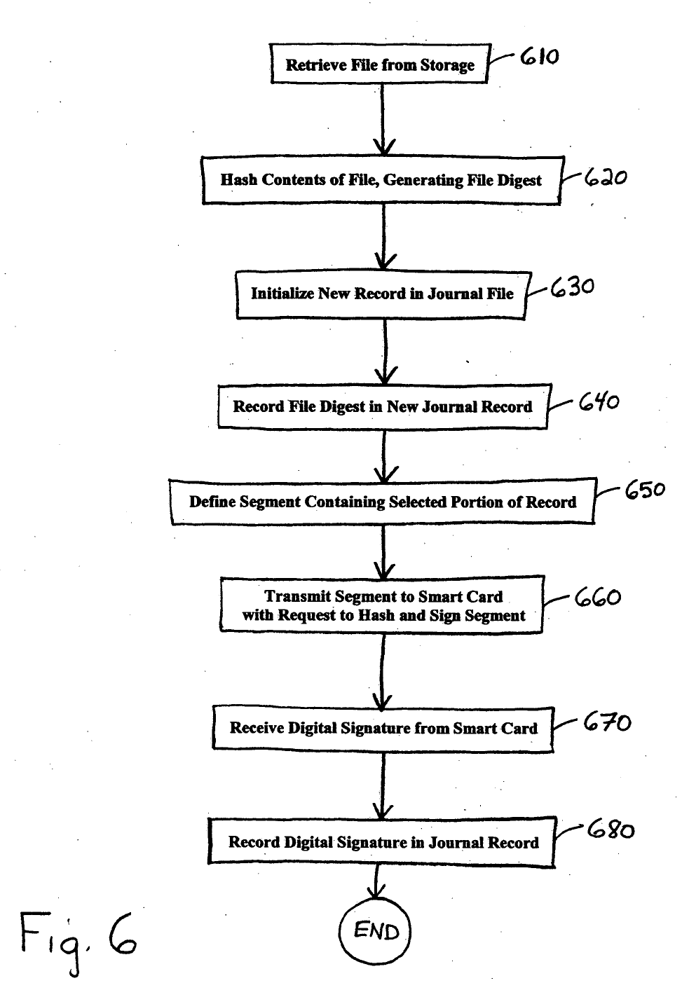

FIG. 6 is a flowchart depicting a routine for locking a selected data file, in accordance with an embodiment of the invention. In this example, after receiving a request to lock a file, e.g., File 1, data protection module 160 accesses volume 215 in storage system 130 and locates the file. At step 610, data protection module 160 retrieves File 1 from storage system 130. At step 620, data protection module 160 hashes the contents of File 1, generating a file digest. In the illustrative embodiment, the message digest 5 (MD5) algorithm is used to generate a digest.

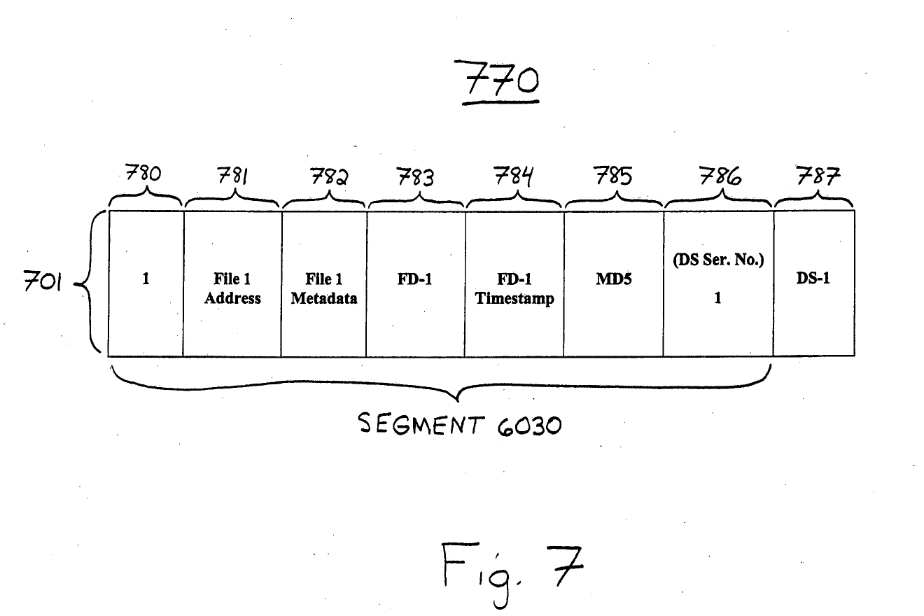

Data protection module 160 initializes a journal file, and at step 630 creates a record therein for storing data pertaining to File 1. FIG. 7 is a schematic illustration of a journal file 770, in accordance with an embodiment. Because File 1 is the first file within volume 215 to be locked, journal file 770 at this point contains only a single record 701, associated with File 1. Record 701 comprises eight fields 780-787. Field 780 stores a record identifier. In this example, data protection module 160 enters “1” as an identifier for record 701. Fields 781-782 store data pertaining to the corresponding file within storage system 130 (File 1 in this instance). For example, field 781 holds an address indicating the location of File 1. Referring to FIG. 2, field 781 may include, for example, “Dir1/File 1.” Field 782 stores metadata associated with File 1. Referring to FIG. 1, journal file 770 is stored in storage system 130 in association with file volume 215.

At step 640, data protection module 160 stores the file digest derived from File 1 in record 701. In the illustrative embodiment, the file digest (represented as “FD-1”) is stored in field 783. Fields 784-785 hold data pertaining to file digest FD-1. Field 784 includes a timestamp indicating the date and time when file digest FD-1 was created, and field 785 holds information identifying the D-G function used to generate file digest FD-1. In this example, the MD5 algorithm was used to generate file digest FD-1; accordingly, data representing the MD5 algorithm is entered in field 785. Fields 786-787 store data pertaining to a digital signature generated based, at least in part, on file digest FD-1. Field 786 stores a serial number associated with the digital signature. Field 787 stores the digital signature itself.

Data protection module 160 generates a serial number for the digital signature to be stored in field 786. Assigned serial numbers may start at 1 and increase by one for each signature generated. In this example, because the digital signature is to be the first digital signature generated in connection with volume 215, data protection module 160 enters a “1” in field 786.

At step 650, data protection module 160 defines a segment comprising a portion of record 701. In this example, segment 6030 is defined to include data from fields 780-786. Thus, segment 6030 includes record ID data (field 780), file address data (field 781), file metadata (field 782), file digest FD-1 (field 783), timestamp data (field 784), algorithm identifying data (field 785), and a digital signature serial number (field 786). It should be noted that although in this example segment 6030 includes seven fields, a data segment may comprise more or fewer fields. At step 660, data protection module 160 transmits segment 6030 to smart card 125 with a request to hash and sign the segment.

When smart card 125 receives segment 6030, internal program 460 examines the date/time information contained in segment 6030 (e.g., from the timestamp data stored in field 784). Data protection module 460 compares the received date/time information to the start date and expiration date specified in digital certificate 436. If the date/time information received in segment 6030 from data protection module 160 indicates a time before the certificate's start date, or after the certificate's expiration date, internal program 360 informs data protection module that smart card 125 is not authorized to sign the segment.

If the received date/time information falls within the digital certificate's period of validity, then internal program 460 next validates the received date/time information against the date/time information in time log 538. Data protection module 160 first computes an estimated date/time value by adding the value on its internal timer (indicating the amount of time that has elapsed since the last smart card-associated “event”) to the date/time value stored in field 522 of time log 538 (which indicates the date and time of the last “event”). Data protection module 160 then compares the estimated date/time to the received date/time information. If the received date/time information deviates more than a predetermined amount from the estimated date and time, internal program 460 informs data protection module 160 that smart card 125 has detected a date/time error and is not authorized to sign the segment.

Internal program 460 additionally compares the serial number information received in field 786 of segment 6030 with the serial number information stored in field 523 of time log 538. The received serial number information should equal the value stored in field 523 of time log 538, plus one. If the received serial number value does not equal the serial number stored in time log 538, plus one, internal program 460 informs data protection module 160 that a serial number error has been detected, and that the segment cannot be processed. In the illustrative example, field 786 of segment 6030 contains “1,” and the value in field 523 of time log is zero. Accordingly, internal program 460 deems the serial number information contained in segment 6030 to be valid.

If the date/time and serial number information received from data protection module 160 are determined to be valid, internal program 460 hashes segment 6030 to generate a segment digest. Internal program 460 then signs the segment digest using private key 445, generating a digital signature.

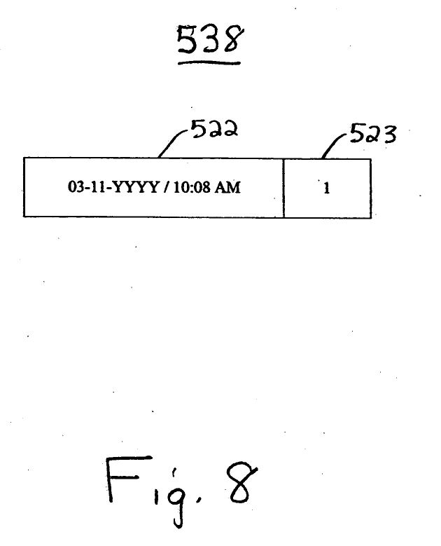

Internal program 460 updates time log 538 to reflect the signing “event.” Internal program 460 updates field 522 to reflect the current date and time, and increases the counter value in field 523 by one. FIG. 8 shows time log 538 after fields 522 and 523 have been updated to reflect the signing operation performed with respect to segment 6030. Field 522 now contains the date/time data received with segment 6030 from data protection module, which is “03-11-YYYY/10:08 AM” in this example. Field 523 now holds a one, indicating that smart card 125 has now generated one digital signature. Internal program 460 also resets the internal timer to zero.

After time log 538 is updated, smart card 125 transmits the digital signature to data protection module 160. Referring again to FIG. 6, data protection module 160 at step 670 receives the digital signature. Referring now to journal file 770 shown in FIG. 7, the digital signature (represented as DS-1) is stored in field 787 of record 701 (step 680).

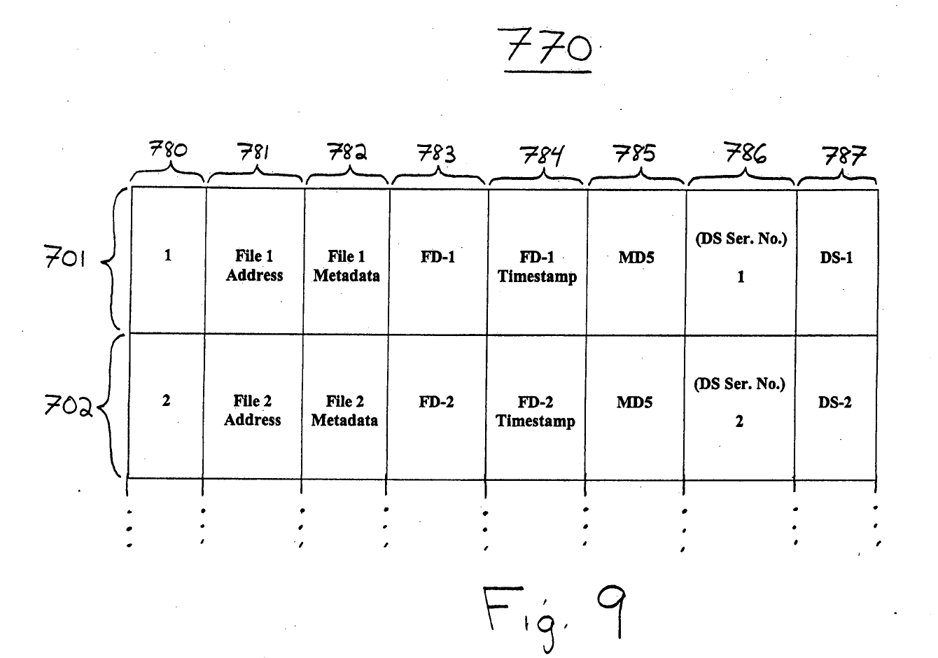

The technique described above may be applied to other files currently stored in volume 215, e.g., File 2, File 3, etc., as well as to files that may be subsequently added to volume 215. Data protection module 160 generates a separate record in journal file 770 for each file which is locked. For example, FIG. 9 is a schematic illustration of journal file 770 containing multiple records corresponding to various files in volume 215. Record 702 corresponds to File 2, and includes a record identifier, file address data for File 2, file metadata, a file digest FD-2, file digest timestamp data, algorithm identifying data, a signature serial number, and a digital signature DS-2, in columns 780-787, respectively.

Verification of Data

At a subsequent time, XYZ Company may wish to verify the integrity of the data in a selected file to determine that it has not been corrupted. To verify the integrity of a file, e.g., File 1, data protection module 160 accesses journal file 770, examines record 701, verifies the contents of the segment corresponding to signature DS-1, and then verifies the contents of File 1.

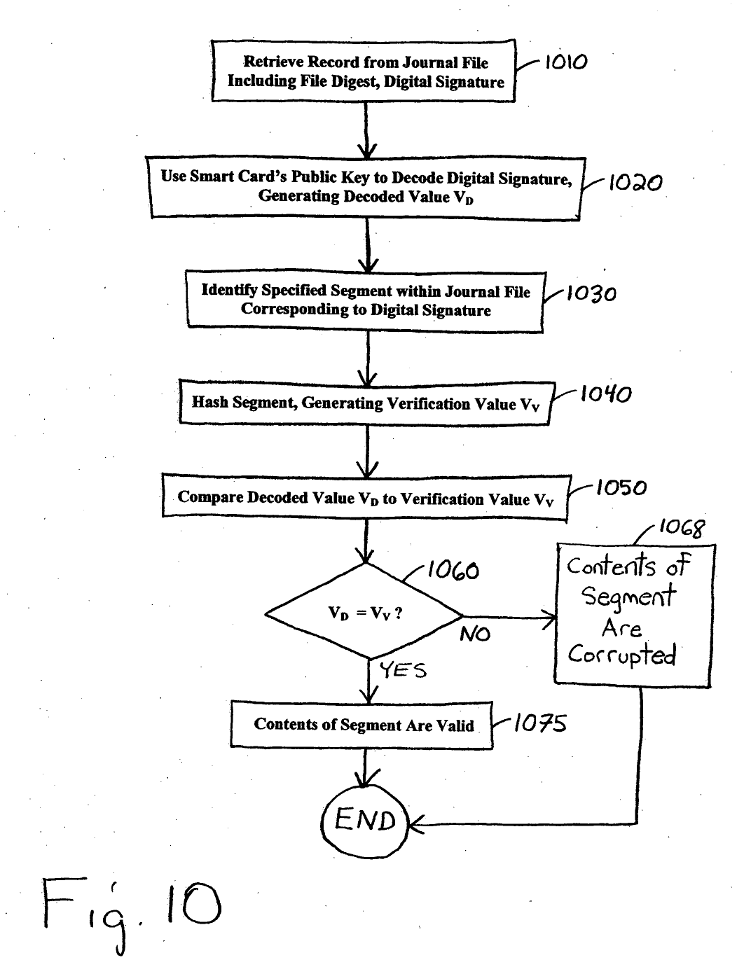

FIG. 10 is a flowchart depicting a routine for verifying the contents of a segment corresponding to a digital signature stored within journal file 770. Data protection module 160 accesses journal file 770, and at step 1010 retrieves a selected record, e.g., record 701 shown in FIG. 7. Accessing field 787 of the record, data protection module 160 retrieves digital signature DS-1. The public key 433 of smart card 125 is used to decode digital signature DS-1, generating a decoded value V_{D}. At step 1030, data protection module 160 determines that the segment corresponding to digital signature DS-1 includes fields 780-786. Accordingly, data protection module 160 recreates segment 6030 using the contents of these respective fields, and at step 1040 hashes the segment to create a verification value V_{V}. At step 1050, data protection module 160 compares the decoded value V_{D} to verification value V_{V}. Referring to block 1060, if V_{D} equals V_{V}, the contents of segment 6030 are deemed valid (block 1075). If V_{D} is not equal to V_{V}, the contents of segment 6030 are deemed to be corrupted (block 1068).

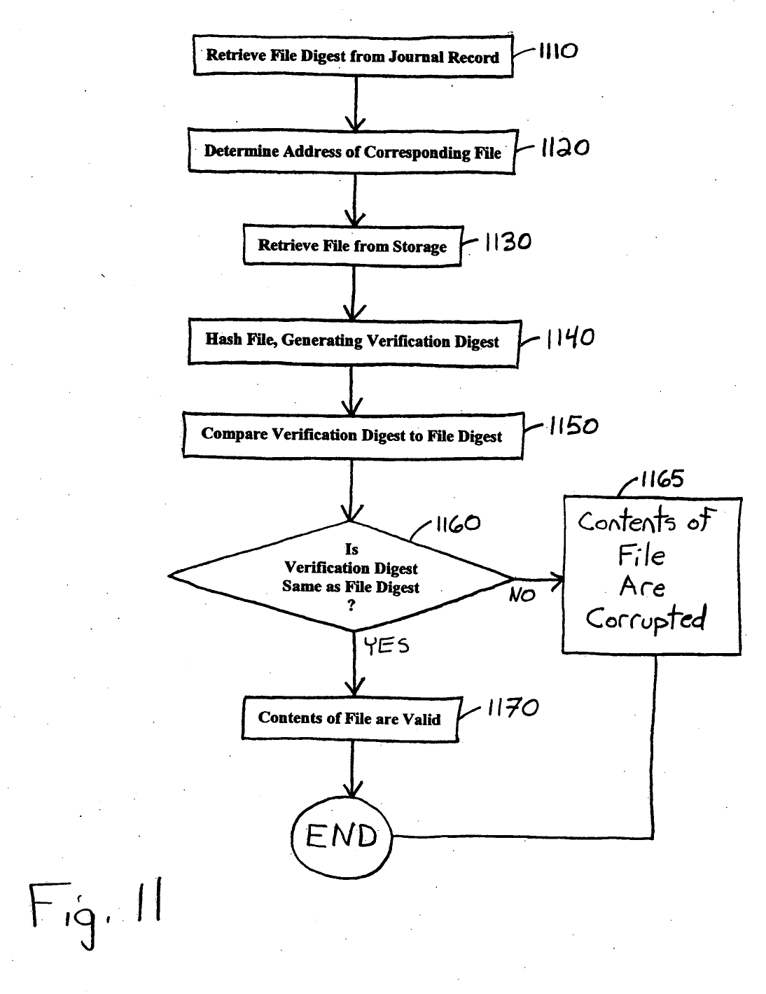

Assuming that segment 6030 is determined to be valid, data protection module 160 now verifies that the contents of File 1 are still valid. Referring to FIG. 11, at step 1110 data protection module 160 retrieves file digest FD-1 from field 783 of record 701. At step 1120, data protection module 160 determines the address of File 1 by examining field 781 of the record, and then retrieves File 1 from storage system 130 (step 1130). At step 1140, data protection module 160 hashes the contents of File 1, generating a verification digest. At step 1150, the verification digest is compared to file digest FD-1. In accordance with block 1160, if the verification digest and file digest FD-1 are the same, the contents of File 1 are determined to be valid (block 1170). If the verification digest is not the same as file digest FD-1, then the contents of File 1 are deemed to be corrupted. At this point, the routine comes to an end.

### Alternative Embodiments

Various aspects of the technique described above may be adjusted to suit the requirements of the owner of the data to be protected, or to accommodate the technical capabilities of storage system 130. For example, in accordance with an alternative embodiment, data processing module 160 generates a journal file as described above with reference to FIG. 7, and, in addition, generates one or more cascaded values based on data selected from multiple records. A digital signature stored in a selected record is combined with selected data stored in one or more previous records, thereby generating a cascaded value. The cascaded value is stored in the selected record. Generating and storing cascaded values in this manner facilitates the detection of corrupted data. Data protection module 160 may subsequently detect changes that have occurred in the selected record, or in any of the one or more previous records, by recomputing the cascaded value and comparing the recomputed value to the stored cascaded value. For example, data protection module 160 may use cascaded values stored in a journal file to determine whether the order of records in the journal file has been altered.

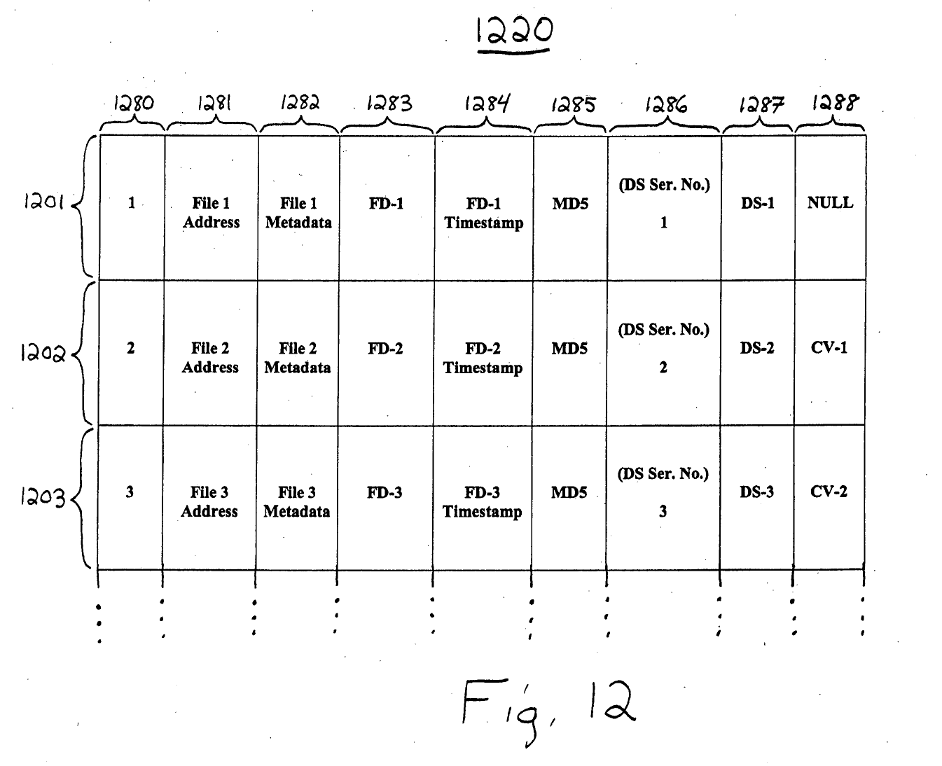

By way of illustration, let us suppose that data protection module 160 is directed to protect the files in volume 215, and in response, generates a journal file such as that shown in FIG. 12. Journal file 1220 includes nine columns 1280-1288. Columns 1280-1287 store a record identifier, file address information, file metadata, a file digest, a file digest timestamp, algorithm identifying data, a digital signature serial number, and a digital signature, respectively. Column 1288 may store a cascaded value.

When a first file is selected from volume 215, e.g., File 1, and the first record (record 1201) is generated, data protection module 160 populates columns 1280-1287 of the record in the manner described above, e.g., with reference to FIG. 7. Thus, file digest FD-1 is generated based on the contents of File 1 and stored in column 1283. Additional information is entered in columns 1280-1282 and columns 1284-1286 of the record. A segment is defined (e.g., to include fields 1280-1286), a signature is generated based on the contents of the segment, etc. The signature is stored in column 1287 of the record. However, in the first record a NULL value is entered in column 1288.

When a second file, e.g., File 2, is selected, and the second record (record 1202) is generated, columns 1280-1287 are again populated in a similar manner. However, to provide an additional level of security, data protection module 160 transmits the digital signature which is stored in column 1287 of record 1202, DS-2 in this instance, and the contents of the previous record (record 1201 in this instance), to smart card 125 with a request to hash the values and produce a digital signature. Smart card 125 hashes digital signature DS-2 with the contents of record 1201, generating a hash value, and signs the hash value, producing a cascaded value. Smart card 125 returns the cascaded value to data protection module 160. Data protection module 160 receives and stores the cascaded value (represented as CV-1) in column 1288 of record 1202.

When the third record (record 1203) is generated (based on File 3), columns 1280-1287 are again populated in a similar manner. Now, data protection module 160 transmits the digital signature stored in column 1287 of record 1203 (DS-3 in this instance) and the contents of the previous record 1202 to smart card 125 with a request to hash and sign the values. Smart card 125 hashes the values, and signs the resulting hash value, producing a cascaded value. Smart card 125 transmits the cascaded value to data protection module 160. Data protection module 160 stores the cascaded value (represented as CV-2) in column 1288 of record 1203. In this embodiment, data protection module 160 repeats the procedure described above for each record generated in journal file 1220.

The integrity of data stored in volume 215 may subsequently be verified using journal file 1220. Data protection module 160 retrieves digital signature DS-1 from column 1287 of record 1201, and uses public key 433 of smart card 125 to decode the signature, generating a decoded value. Data protection module 160 identifies the segment that corresponds to digital signature DS-1, which in this example includes columns 1280-1286 of record 1201. The segment is hashed, and the resulting verification value is compared to the encoded value. If the two values match, the contents of segment are determined to be valid. Data protection module 160 then validates the contents of file 1 using file digest FD-1. File 1 is located and retrieved using the address data stored in column 1281. Data protection module 160 hashes File 1 to generate a verification digest. If the verification digest matches file digest FD-1 stored in column 1283, the contents of File 1 are deemed to) be valid.

Data protection module 160 then proceeds to the next record, record 1202 in this instance, and repeats the procedure described above. Accordingly, the digital signature stored in column 1287 is used to verify the contents of the corresponding segment, and then file digest FD-2 stored in column 1283 is used to verify the contents of File 2. Finally, data protection module 160 examines column 1288 and retrieves cascaded value CV-1. As an additional level of security, data protection module 160 uses cascaded value CV-1 to verify aspects of records 1201 and 1202. For example, cascaded value CV-1 is used to verify that record 1202 did in fact immediately succeed record 1201 in journal file 1220, and therefore that no intervening record has been deleted. Accordingly, data protection module 160 uses public key 433 of smart card 125 to decode cascaded value CV-1, generating a decrypted value. Data protection module 160 separately hashes digital signature DS-2 (in record 1202) with the contents of the previous record 1201, to generate a hash value. If the hash value matches the decrypted value, data protection module determines that record 1202 did indeed immediately follow record 1201 in journal file 1220.

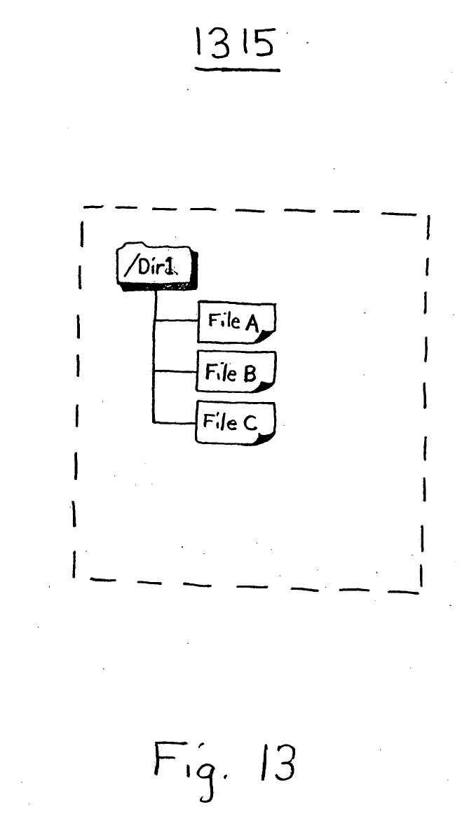

In yet another alternative embodiment, data protection module 160 may examine a selected file volume periodically, and lock all new files that have been saved therein since the previous examination. By way of example, let us suppose that XYZ Company wishes to create a new file volume and add data to the volume from time to time. Suppose further that XYZ Company wishes to perform a data locking operation with respect to the volume once per hour in order to protect any data that is saved therein. Accordingly, XYZ Company creates a new file volume, e.g., volume 1315 shown in FIG. 13, and begins to store data therein. Volume 1315 may be stored in, e.g., storage system 130.

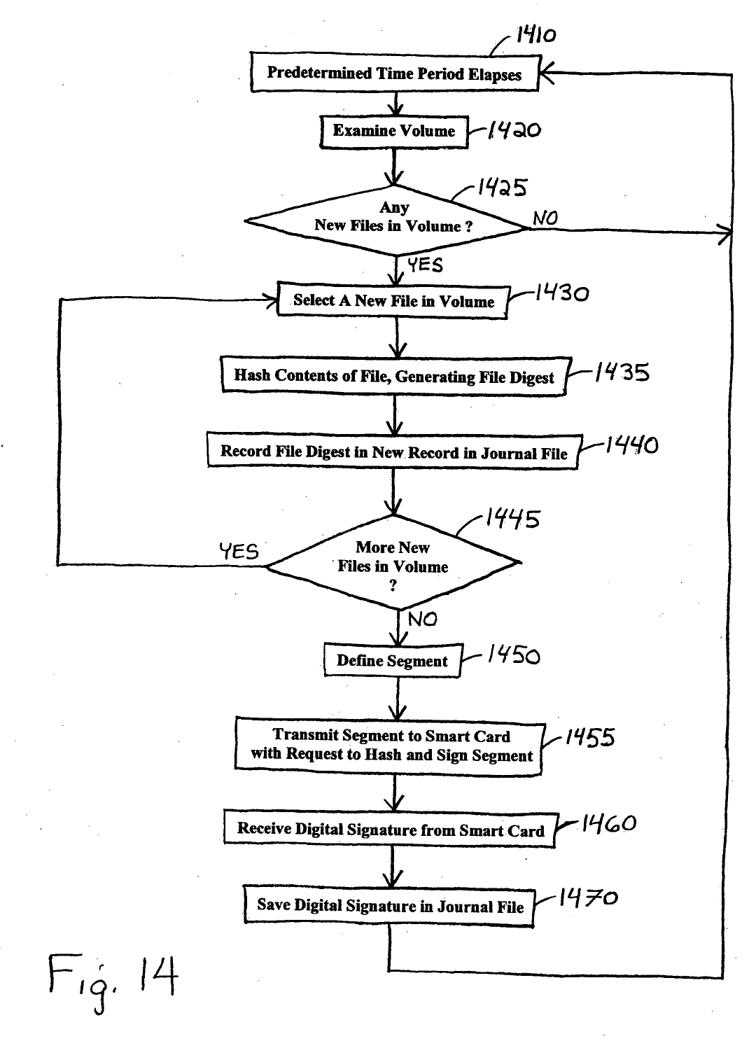

FIG. 14 is a flowchart depicting a routine for periodically locking data saved in a file volume, in accordance with an embodiment. Data protection module 160 is directed to examine volume 1315 once per hour and to lock any data that may be stored therein. Accordingly, referring to step 1410, data protection module 160 allows sixty minutes to elapse. Let us suppose that during the first sixty-minute period, File A, File B, and File C are saved to volume 1315, as shown in FIG. 13. At step 1420, data protection module 160 examines volume 1315, and finds new Files A, B, and C. Thus, in accordance with block 1425, data protection module 160 proceeds to step 1430. In the event no new files are detected in the volume, the routine returns to step 1410 and data protection module 160 allows another sixty minutes to elapse.

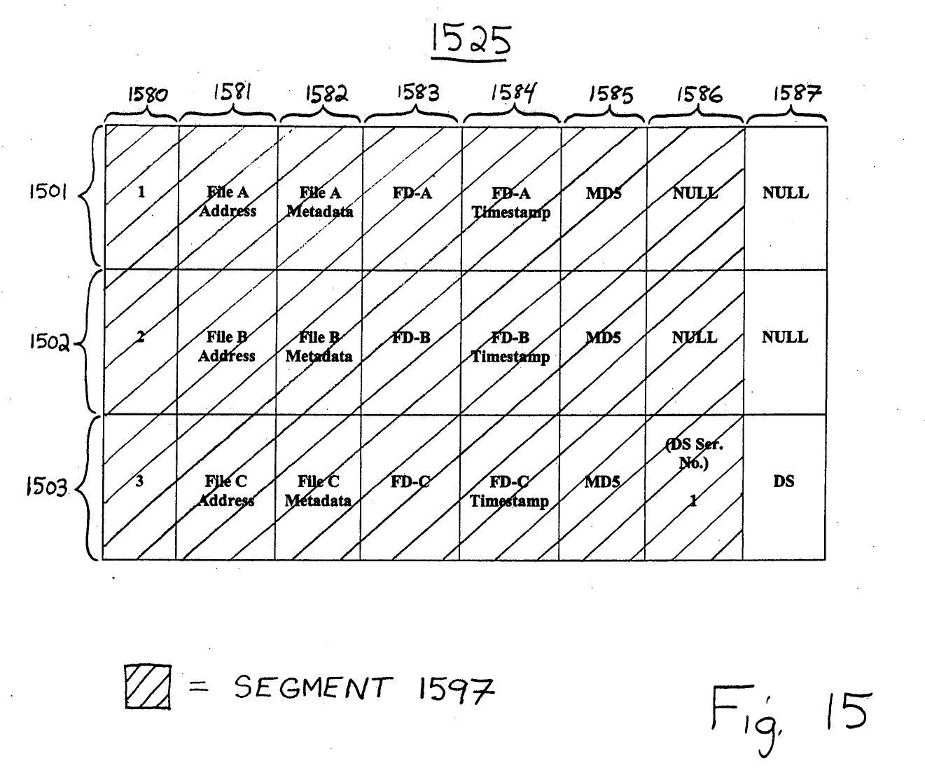

At step 1430, data protection module 160 selects a new file, e.g., File A, from volume 1315 and at step 1435 hashes the file, producing a file digest. Data protection module 160 creates a journal file, and at step 1440 stores the file digest in a record within the journal file. FIG. 15 is a schematic illustration of a journal file 1525 that may be used in this embodiment. In this example, the file digest corresponding to File A (represented as FD-A) is saved in record 1501 (in column 1583). Data protection module 160 also stores a record identifier, file address data and file metadata in columns 1580, 1581, and 1582, respectively. Timestamp data indicating the date and time the file digest was generated, and algorithm identifying data, are recorded in columns 1584 and 1585, respectively. However, in contrast to the embodiment described above, no digital signature is generated or stored in record 1501. Instead, a NULL value is entered in each of columns 1586 and 1587. Referring now to block 1445 of FIG. 14, data protection module 160 detects additional new files in volume 1315, returns to step 1430, and repeats steps 1430, 1435, and 1440 with respect to another new file, e.g., File B, resulting in record 1502 as shown in FIG. 15. Again, no digital signature is generated, and a NULL value is entered in each of columns 1586 and 1587.

When data protection module 160 selects the last new file, (File C in this instance), record 1503 is created and populated in the same manner used for records 1501 and 1502. However, at block 1445, data protection module 160 now determines that there are no new files remaining in volume 1315, and proceeds to step 1450. At step 1450, data protection module 160 defines a segment to include portions of one or more records in journal file 1525. In this example, data protection module 160 defines a segment 1597 including the data stored in columns 1580-1586 of record 1501, columns 1580-1586 of record 1502, and columns 1580-1586 of record 1503. A serial number for a digital signature to be generated based on segment 1597 is entered in column 1586 of record 1503. In this instance, because segment 1597 is the first segment defined in journal file 1525, serial number “1” is assigned and stored in column 1586. At step 1455, segment 1597 is transmitted to smart card 125 with a request to hash and sign the segment. Smart card 125 hashes the segment, generating a segment digest, and signs the segment digest, generating a digital signature. Smart card 125 transmits the digital signature to data protection module 160. The digital signature is received by data protection module 160 at step 1460 and stored in journal file 1525 at step 1470. In this example, the digital signature (represented as ‘DS’) is stored in column 1587 of record 1503. As shown in FIG. 15, journal file 1525 now comprises three records 1501, 1502, and 1503 corresponding to Files A, B, and C, respectively. However, only record 1503 contains a digital signature. Referring to column 1586 of record 1503, digital signature DS is associated with serial number 1, indicating that it is the first digital signature generated by smart card 125 with respect to volume 1315.

At this point, data protection module 160 returns to step 1410 and allows another sixty-minute period to elapse before examining volume 1315 again. Data protection module 160 continues to examine volume 1315 once per hour, and repeats the routine described above whenever one or more new files are detected. At a later time, XYZ Company may verify the contents of volume 1315 in a manner similar to that described above. Data protection module 160 examines journal file 1525 and selects a digital signature, e.g., digital signature DS in record 1503. Data protection module 160 decodes digital signature DS using the smart card's public key 433, generating a decoded value. Data protection module 160 then determines that the segment corresponding to digital signature DS includes fields 1580-1586 of record 1501, fields 1580-1586 of record 1502, and fields 1580-1586 of record 1503. Data protection module 160 hashes the segment, generating a verification value. If the verification value matches the decoded value derived from digital signature DS, the contents of the segment are determined to be valid. Assuming the segment is deemed valid, data protection module may then proceed to validate the contents of each file in the segment (File A, File B, and File C in this instance) in the manner described above.

In yet another alternative embodiment in which data is managed at a block level, data protection module 160 may lock a set of selected data blocks. One or more data blocks, or a portion of a data block, may be defined as a data block set. Data protection module 160 generates a digest based on the data block set, and stores the digest in a record in a journal file. Additional data pertaining to the digest and/or the data block set may also be stored in the record. The journal file is stored in association with the data block set. In a manner similar to the methods described above, data protection module 160 defines a segment comprising a portion of the record, and transmits the segment to smart card 125. Smart card 125 hashes and signs the segment, and returns a digital signature to data protection module 160. The digital signature is stored in the record.

The foregoing merely illustrates the principles of the invention. It will thus be appreciated that those skilled in the art will be able to devise numerous other arrangements which embody the principles of the invention and are thus within its spirit and scope.

We claim:

1. A method for encrypting data comprising:
generating data comprising identification information pertaining to the data;
comparing the identification information to verification data stored in a secure memory;
determining whether the identification information is valid based on a result of the comparison;
retrieving from the secure memory a first value selected from a plurality of asymmetric encryption keys, when the identifying information is determined to be valid; and
generating an encoded value by encoding the data using the first value.

2. The method of claim 1, wherein the identification information comprises time information indicating when the data is generated.

3. The method of claim 1, wherein the identification information comprises a serial number indicating an order in which the data is encoded with respect to other data.

4. The method of claim 1, wherein the secure memory is located in a smart card.

5. The method of claim 1, wherein the secure memory is located in a smart token.

6. The method of claim 1, further comprising:
generating a digest based at least in part on a selected data file; and
generating the data based at least in part on the digest.

7. The method of claim 6, wherein the digest is generated using a hash function.

8. The method of claim 7, wherein the hash function comprises a message digest 5 algorithm.

9. The method of claim 7, wherein the hash function comprises a secure hash algorithm.

10. The method of claim 1, wherein the encoded value comprises a digital signature.

11. The method of claim 1, further comprising storing the encoded value in association with the data.

12. The method of claim 1, further comprising storing the encoded value and the data in a record.

13. The method of claim 12, further comprising:
generating a cascaded value based on the encoded value and a portion of a second record; and
storing the cascaded value in the record.

14. The method of claim 1, further comprising:
generating a digest based at least in part on one or more selected data blocks; and
generating the data based at least in part on the digest.

15. A system for encrypting data comprising:
a first processor to generate data comprising identification information pertaining to the data;
a device comprising:
a secure memory to store a first value selected from a plurality of asymmetric encryption keys, and verification data; and
a second processor configured to:
compare the identification information to the verification data stored in the secure memory;
determine whether the identification information is valid based on a result of the comparison; and
generate an encoded value by using the first value to encode the data, when the identification information is determined to be valid.

16. The system of claim 15, wherein the identification information comprises time information indicating when the data is generated.

17. The system of claim 15, wherein the identification information comprises a serial number indicating an order in which the data is encoded with respect to other data.

18. The system of claim 15, wherein the secure memory is located in a smart card.

19. The system of claim 15, wherein the secure memory is located in a smart token.

20. The system of claim 15, wherein the second processor comprises a component of a smart card.

21. The system of claim 15, wherein the first processor is further configured to:
generate a digest based at least in part on a selected data file; and
generate the data based at least in part on the digest.

22. The system of claim 21, wherein the first processor is further configured to generate the digest using a hash function.

23. The system of claim 22, wherein the hash function comprises a message digest 5 algorithm.

24. The system of claim 22, wherein the hash function comprises a secure hash algorithm.

25. The system of claim 15, wherein the encoded value comprises a digital signature.

26. The system of claim 15, wherein the first processor stores the encoded value and the data in a record.

27. The system of claim 26, wherein the first processor is further configured to:
generate a cascaded value based on the encoded value and a portion of a second record; and
store the cascaded value in the record.

28. The system of claim 15, wherein the first processor is further configured to:
generate a digest based at least in part on one or more selected data blocks; and
generate the data based at least in part on the digest.

29. A method for verifying data stored in a communication system, comprising:
retrieving from storage data and an associated encoded value, the associated encoded value being generated using a first value selected from a plurality of asymmetric encryption keys;
generating a decoded value by decoding the encoded value using a second value selected from the plurality of asymmetric encryption keys;
comparing the decoded value to the data; and
determining whether the data is valid based on a result of the comparison.

30. The method of claim 29, wherein the first value is stored in a smart card.

31. The method of claim 29, wherein the encoded value is generated by a smart card.

32. The method of claim 29, wherein the encoded value comprises a digital signature.

33. The method of claim 29, further comprising:
generating a digest based at least in part on the data; and
comparing the decoded value to the digest.

34. The method of claim 33, further comprising generating the digest using a hash function.

35. The method of claim 34, wherein the hash function comprises a message digest 5 algorithm.

36. The method of claim 34, wherein the hash function comprises a secure hash algorithm.

37. The method of claim 34, wherein the hash function comprises a cyclic redundancy check technique.

38. The method of claim 29, wherein the data includes a file digest generated based at least in part on a data file stored in the communication system.

39. The method of claim 38, wherein the data further comprises information indicating when the file digest is generated.

40. The method of claim 38, wherein the data further comprises information indicating an address of the data file.

41. The method of claim 38, wherein the encoded value is stored in association with the data file.

42. The method of claim 29, wherein the data comprises multiple digests each generated based in part on a respective file stored in the communication system.

43. The method of claim 29, wherein the data comprises a second encoded value generated using the first value, the second encoded value corresponding to second data stored in the communication system, and a third encoded value generated using the first value, the third encoded value corresponding to third data stored in the communication system.

44. A system to verify data stored in a communication system, comprising:
storage to store data and an associated encoded value generated using a first value selected from a plurality of asymmetric encryption keys; and
a processor programmed to retrieve the data and the associated encoded value from the storage, to generate a decoded value by decoding the encoded value using a second value selected from the plurality of asymmetric encryption keys, to compare the decoded value to the data, and determine whether the data is valid based on a result of the comparison.

45. The system of claim 44, wherein the processor is further programmed to:
generate a digest based on the data; and
compare the decoded value to the digest.

46. The system of claim 45, further comprising generating the digest using a hash function.

47. The system of claim 46, wherein the hash function comprises a message digest 5 algorithm.

48. The system of claim 46, wherein the hash function comprises a secure hash algorithm.

49. The system of claim 46, wherein the hash function comprises a cyclic redundancy check technique.

50. The system of claim 44, wherein the first value is stored in a smart card.

51. The system of claim 44, wherein the encoded value is generated by a smart card.

52. The system of claim 44, wherein the encoded value comprises a digital signature.

53. The system of claim 44, wherein the data includes a digest generated based at least in part on a data file stored in the communication system.

54. The system of claim 53, wherein the data further comprises information indicating when the digest is generated.

55. The system of claim 53, wherein the data further comprises information indicating an address of the data file.

56. The system of claim 53, wherein the encoded value is stored in association with the data file.

57. The system of claim 44, wherein the data comprises multiple digests each generated based in part on a respective file stored in the communication system.

58. The system of claim 44, wherein the data comprises a second encoded value generated using the first value, the second encoded value corresponding to second data stored in the communication system, and a third encoded value generated using the first value, the third
encoded value corresponding to third data stored in the communication system.
